(19) United States
(12) Patent Application Publication
(10) Pub. No.: US 2006/0072739 A1
(43) Pub. Date: Apr. 6, 2006

(54) Method and system for assessing and deploying personnel for roles in a contact center

(75) Inventors: Rick Baggenstoss, Decatur, GA (US); Kathleen C. Lendvay, Seattle, WA (US); Dianna J. Spence, Suwanee, GA (US)

Correspondence Address: Robert T. Neufeld, Esq.;KING & SPALDING LLP, 45th Floor, 191 Peachtree Street, N.E., Atlanta, GA, 30303, US

(73) Assignee: Knowlagent Inc., Alpharetta, GA (US)

(21) Appl. No.: 10/957,350

(22) Filed: Oct. 1, 2004

(51) Int. Cl. H04M 3/00; H04M 5/00

(52) U.S. Cl. 379/265.05

(57) ABSTRACT

Improving the deployment of human resources in a work environment and particularly in a contact center environment. Agents working in a contact center are given different assignments based on their skills and proficiencies. Conventional contact centers typically use a static skills resume to evaluate their agents for particular roles. The present invention enables call centers to design customized assessment tools for evaluating their agents. By tailoring the attributes considered important for a particular role, a call center can more accurately, more efficiently, and more easily assess which agents are best-suited for a particular role.

### TECHNICAL FIELD

The present invention relates generally to contact centers, such as call service centers, for managing contact communications and, more specifically, to effectively assessing personnel, both existing and potential, based upon personal characteristics to be utilized in roles in a contact center.

### BACKGROUND OF THE INVENTION

A conventional contact center can take a variety of forms and implement various communication methods for its agents and constituents. Some examples of contact centers include a call center, an email help desk, a Web-based chat room, or a wireless support system. One example, the call center, comprises a system that enables a staff of customer service agents to service telephone calls to or from customers or other constituents. Customer service agents are on the front line with customers. Each interaction is mission critical to the organization, as it can make or break a customer relationship. Customer satisfaction is directly tied to how well each call is handled. In fact, according to studies by The Center for Customer-Driven Quality at Purdue University, 90% of the public forms its perception of a company based on customer service experiences. One such study reports that over 60% of the public would terminate a relationship with a company based upon a bad experience with a customer service center agent.

Unfortunately, Gartner reports a large gap between an organization's perceptions of how well its customer service center meets the needs of its customers and the customer's reality. Although 70% of enterprises believe they have well-run customer service centers that provide their customers with good service, only 46% of their customers report satisfaction with that service.

Successful change—whether new product introductions, or the transformational change hoped for in initiatives such as customer relationship management (CRM)—is driven by agents. However, too often, customer service agents lag behind the organization during change. Unless agents are informed, understand change, and implement it in their daily customer interactions, change will not have its intended effect.

Compounding this is the fact that the contact center environment demands the ability to adapt to such change at a rapid pace. Each contact center comprises a considerable volume of customer service agents, among whom there is an often-high turnover rate. Therefore, there is an omnipresent need to hire and train agents and, based upon agent skills, personality traits, and other personal characteristics, to assign and re-assign the right agents, with the right supervisors, to the right calls, tasks, and other assignments.

Typically, contact centers manage this need by testing potential and existing agents' skill levels, reporting test results in static “skill resumes,” and using each agent's skill resume to make hiring, training, and assignment decisions. Generally, skill tests are personally administered by supervisors and/or human resource employees. The more effective skill tests, by necessity, are thorough, forcing test administrators to spend significant time assessing the skill sets of each agent.

For skill resumes to be up-to-date and accurate, skill tests must routinely be administered, a process that heretofore has been impracticable in light of the constant hiring, training, assigning, and re-assigning needed in a contact center environment. Continuous agent evaluation is necessary for shifts in the business of the contact center (e.g., shifts in the call volume of the center), in the goals and objectives of the business, and perhaps more importantly, in the skills and abilities of contact center agents, to be considered in hiring, training, assignment, and call-routing decisions.

A contact center's call volume generally fluctuates, both predictably and unpredictably. When call volume is high, an agent with a history of handling calls quickly but with average quality may produce more value for the contact center than would an agent with a history of handling calls slowly but with high quality.

It is not uncommon for a contact center's management to alter the center's objectives. Management may gauge the center's operational effectiveness according to profit in one season and according to maximum number of customers served in a later season, for example. In the first season, an agent with a history of meticulously converting calls into high-dollar sales might make a larger contribution to the operational effectiveness of the contact center than would an agent with a history of rapidly converting calls into small-dollar sales. But for the later season, the fast-selling agent might make the larger contribution to the overall objective of the organization.

Agents' skill levels generally change through training, experience, and management guidance. The change is sometimes rapid and unpredictable. For example, suppose an agent receives computer-based training during a 15-minute break to learn about a special promotional offer. The promotion just aired in an infomercial and inundated the contact center with inquiries. After that training break, the center's operational effectiveness may be best served by assigning the newly trained agent to many of the inquiry calls.

Further, agent skill levels do not necessarily directly correlate to agent performance. For example, a highly skilled, highly trained agent might handle calls slowly. The slow-handling condition might be correlated to a situation or measurable parameter. For example, suppose an infomercial periodically airs a promotional offer that predictably triggers a backlog of impatient callers and a spike in call volume. Some agents, who are excellent performers on average, may buckle under the pressure. For such agents, performance may be linked to call volume. By focusing solely on agents' skills, typical agent skill tests don't account for additional agent personal characteristics, including personality traits, which might be critical for success in a particular role. Without taking such characteristics into account, managers typically make important business decisions while lacking much relevant information. For example, they may predict agent performance without a thorough understanding of the implications that each agent's personality traits have on that performance.

Next, typical agent skill tests point out agent skill deficiencies without providing options for addressing them. The agent and/or the supervisor must personally arrange for further training. In doing so, they typically take an all-or-nothing approach, placing all or no agents in the same training courses, along the same placement/promotion paths. Generally the focus is on skills that can be trained and developed, while ignoring, for example, personality strengths and weaknesses of agents. Such a one-size-fits-all approach is ineffective in the call-center context—supervisors are wasting time and effort by failing to recognize the personal training needs that different learning styles and other personal characteristics require.

In view of the foregoing, there is a need for a contact center agent assessment and deployment system, which efficiently and continuously evaluates agents' personal characteristics to accurately predict and analyze which agents (and potential agents) to place with which supervisors and for which jobs and assignments. Further, there is a need for such a system to help a contact center effectively train and manage its agents according to each agent's personal training needs and learning styles. The present invention solves these needs.

### SUMMARY OF THE INVENTION

The present invention overcomes the foregoing limitations of the prior art by providing a system and method for more accurately assessing and deploying personnel for roles. The benefits of the present invention are readily apparent in a contact center environment where there are often numerous personnel having different attributes and a variety of different roles for which the personnel can be deployed. Specifically, the present invention allows a contact center manager, for example, to uniquely define a role within the contact center so that the best people can be selected to perform that role. Giving the call center manager the ability to customize the role definition based on the particular call center provides for more accurate assessment and deployment decisions. Instead of a one-size-fits-all checklist of attributes, the present invention provides a customized tool for each role in a particular contact center.

In one embodiment, the present invention provides a method for using assessment data collected for particular agents in a contact center. A deployment module can receive a definition for a role (a “role definition”), where the definition comprises one or more models. A model is a general collection of one or more personal characteristic rules associated with such personal characteristics as e.g., personality traits, skills, knowledge, and preferences. Each model can comprise one or more personal characteristic rules. The deployment module uses the role definition to perform calculations on the collected assessment data for the agents. The deployment module can calculate an overall score for an agent using the formula prescribed by the role definition.

In another embodiment, the present invention provides a method for a contact center manager to use a deployment module to decide how to deploy agents for roles in the contact center. The contact center manager arranges for a group of agents to take an assessment, producing assessment data. The contact center manager uses the deployment module to define a particular role in the contact center. The manager can define the role by selecting one or more personal characteristic rules corresponding to personal characteristics identified within the deployment module. The manager can also group the personal characteristic rules into models and use the models to define roles within the deployment module. Once the manager has defined a role, he can use the deployment module to calculate the preferred agents for the role. The deployment module applies the definition of the role to the assessment data.

In yet another embodiment, the present invention provides a contact center manager with a method to adjust role assignments within the contact center. The manager can identify a preferred agent that is performing favorably in a particular role. The manager can use the deployment module to identify one or more significant personal characteristics for the favorably performing agent that are relevant to the role. The manager can then use the deployment module to retrieve the role definition for the role and identify any discrepancies between the current role definition and the one or more significant personal characteristics identified for the favorably performing agent. If appropriate, the manager can modify the role definition to emphasize (or deemphasize, as the case may be) the one or more significant personal characteristics.

In yet another embodiment, the present invention provides a system for deploying personnel in a contact center. The system comprises a deployment module operable for defining particular roles within the contact center. The role definitions are customizable and comprise one or more models. The models comprise one or more personal characteristic rules that are associated with one or more personal characteristics. The role definition provides a formula for calculating a preferred agent for a role. The system also comprises assessment data gathered for agents working in the contact center. The deployment module can access the assessment data and calculate a preferred agent for a role by applying the formula of the role definition.

The discussion of assessing and deploying personnel presented in this summary is for illustrative purposes only. Various aspects of the present invention may be more clearly understood and appreciated from a review of the following detailed description of the disclosed embodiments and by reference to the drawings and claims.

### BRIEF DESCRIPTION OF THE DRAWINGS

FIGS. 1A and 1B, together comprising FIG. 1, are block diagrams illustrating the architecture of a system for managing a computer-based contact center system according to an exemplary embodiment of the present invention.

FIG. 2 is a flow chart illustrating steps in a process for assessing and deploying personnel for a role in a computer-based contact center according to an exemplary embodiment of the present invention.

FIG. 3 is a flow chart illustrating steps in a sub-process for defining a role according to an exemplary embodiment of the present invention.

FIG. 4 is a flow chart illustrating steps in a sub-process for calculating personal characteristic rule scores according to an exemplary embodiment of the present invention.

FIG. 5 is a flow chart diagram illustrating steps in a process for modifying the definition of a role according to an exemplary embodiment of the present invention.

### DETAILED DESCRIPTION OF EXEMPLARY EMBODIMENTS

The present invention is directed to assessing personnel, i.e. agents, for roles in a contact center. Effectively evaluating agents, both existing and potential, based upon personal characteristics to be utilized in such roles can enhance a center's operational effectiveness.

The term “contact center” is used herein to include centers, such as service centers, sales centers, customer-facing centers, call centers that service inbound and/or outbound calls, and contact centers that service e-mails, pages, and other types of communications. As further described below, a contact center can serve customers or constituents that are either internal or external to an organization, and the service can include audible communication, chat, and/or e-mail. A contact center can be physically located at one geographic site, such as a common building or complex. Alternatively, a contact center can be geographically dispersed and include multiple sites with agents working from home or in other telecommuting arrangements.

The term “state” or “contact center state” is used herein to refer to situational factors that can effect the contact center's overall operations. Contact center states include agent performance indicators that are aggregated to the entire center and/or the center's agent population. Other state examples include current call volume, historical call volume, and forecast call volume, each of which is sometimes described seasonally or over another increment of time. Further examples of contact center state include the center's overall customer satisfaction index, compliance statistics, revenue goals, actual revenue, service level, new product roll out schedules, management directives, natural disasters, and catastrophic events. This is not an exhaustive recitation.

The term “role” is used herein to refer to any assignment, task, training course, or contact, delegated to any contact center employee, including where and to which supervisor and/or subordinate(s) an agent is assigned.

The term “performance,” with respect to an agent, is used herein to refer to metrics of an individual agent's actual on-the-job performance. Performance indicators include quality, contact handling time, first contact resolution, cross-sell statistics, revenue per hour, revenue per contact, contacts per hour, and speed of answer, for example. Agent performance reflects an aspect of an agent's demonstrated service of a real contact.

Agent skill levels are distinct from agent performance. While agent skill levels sometimes correlate to on-the-job performance, this relationship is not absolute. For example, an agent who is highly trained on the technical aspects of diamonds may be an inept diamond seller as measured by actual, on-the-job performance. Additionally, a highly skilled, highly trained agent might handle calls slowly. The slow-handling condition might be correlated to a situation or measurable parameter. For example, suppose an infomercial periodically airs a promotional offer that predictably triggers a backlog of impatient callers and a spike in call volume. Some agents, who are excellent performers on average, may buckle under the pressure

Agent performance qualifications are based upon agents' personal characteristics. As used herein, the term “personal characteristic” refers to an agent's skills, competencies, innate traits such as cognitive skills and personality, as well as an agent's personal preferences and supervisor, subordinate, and/or interviewer feedback. Foreign language fluencies, product expertise acquired by training in specific products, and listening skills are examples of an agent's skill and competency qualifications.

The term “traits” as used herein refers to basic indicators of an individual's personality. Such traits include assertiveness, cognitive ability, competitiveness, consistency, extraversion, organization, and sensitivity, for example. People vary in their trait strengths. For example, some people are highly organized while others are less so. Different roles require different personality trait strengths in employees. For example, some roles require a high degree of organization (e.g., a role with many minute details) while other roles require less organization (e.g., a role where tasks are often interrupted by external factors).

The term “role definition” is used herein to refer to the characteristics of the ideal agent for a particular role. A role definition is comprised of one or more components referred to simply as “models.” Within the role definition, each model can be weighted for its overall importance to the role definition. For example, if a role definition comprises two models, Model A and Model B, each can be weighted to illustrate its importance to the role definition as compared to the other. E.g., Model A might be weighted 40% and Model B might be weighted 60% to indicate the degree of heightened significance Model B should be given in the role definition. Each model comprises one or more personal characteristic rules.

The term “personal characteristic rules” as used herein refers to the levels of desirability for particular personal characteristics in a role. For example, there can be an “Organization Max” personal characteristic rule where a high degree of organization is desired. Conversely, there can be an “Organization Min” personal characteristic rule where a minimal degree of organization is desirable. Furthermore, a personal characteristic rule can identify optimal levels for a personal characteristic between designated minimal and maximum levels. For example a “Cognitive Skill 40” personal characteristic rule could represent a case in which a score of 40% for cognitive skills is considered the optimal level of that personal characteristic. Additionally, within each personal characteristic rule, a level for the elasticity of the rule might be set. Elasticity, as used herein, refers to how close to 100% a score must be to be considered a strong fit verses a moderate fit or a weak fit. Most roles require multiple personal characteristics and these characteristics can be blended in different proportions, e.g., high organization is very important, high cognitive skills is moderately important, low sensitivity is somewhat important, and high typing speed is moderately important.

This blended combination of personal characteristic rules forms a model. Each role definition is built by these models. For example, a claim support role might include an assertiveness model, which has personal characteristic rules for assertiveness and insensitivity, as well as an analytical model, which has personal characteristic rules for organization and cognitive ability. In blending personal characteristic rules and models, weights are applied to each to indicate the importance of the particular personal characteristic rule to the model and the importance of the model to the role definition respectively. The applied weights are percentage points from 0%-100%, represented below numerically on a scale from 0 to 1.

A typical computer-based contact center is an information rich environment. A network of data links facilitates information flow between the center's component systems. By tapping this network, the present invention can access real-time information from various center components and utilize it in the agent assessment process. Consequently, the present invention can be immediately responsive to new situations in the contact center environment, to fluctuations in contact center activity, and to other changes in the center's state.

Although the preferred embodiment of the invention will be described with respect to assessing an agent for a role in a call center, those skilled in the art will recognize that the invention may be utilized in connection with other operating environments. One example other than a traditional call center environment is a technical support center within an organization that serves employees or members. A further example is a customer-facing environment such as a bank branch or a retail store.

More generally, the business function provided by a contact center may be extended to other communications media and to contact with constituents of an organization other than customers. For example, an e-mail help desk may be employed by an organization to provide technical support to its employees. Web-based “chat”-type systems may be employed to provide information to sales prospects. When a broadband communications infrastructure is more widely deployed, systems for the delivery of broadband information, such as video information, to a broad range of constituents through constituent contact centers will likely be employed by many organizations.

The present invention includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Turning now to the drawings, in which like numerals indicate like elements throughout the several figures, an exemplary embodiment of the invention is described in detail.

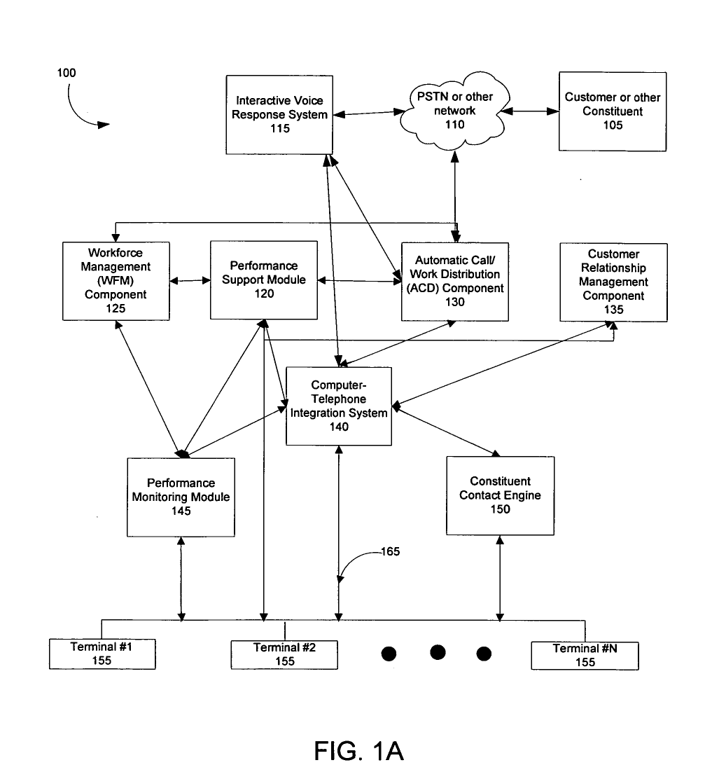

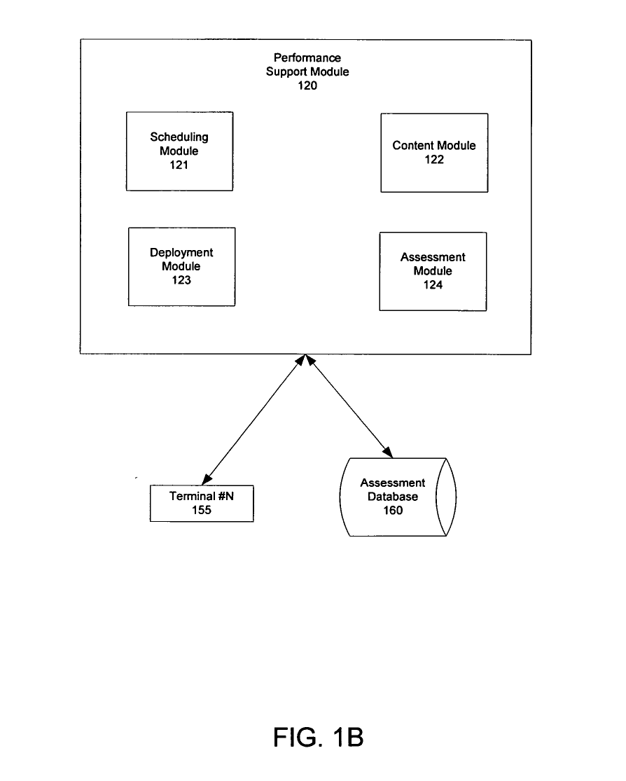

FIG. 1, comprising FIGS. 1A and 1B, illustrates the overall architecture of a system 100 for managing a computer-based contact center system according to an exemplary embodiment of the present invention. Those skilled in the art will appreciate that FIG. 1 and the associated discussion are intended to provide a general description of representative computer devices and program modules.

A contact center 100 includes an arrangement of computer-based components coupled to one another through a set of data links 165 such as a network 165. While some contact center functions are implemented in a single center component, other functions are dispersed among components. The information structure of the contact center 100 offers a distributed computing environment. In this environment, the code behind the software-based process steps does not necessarily execute in a singular component; rather, the code can execute in multiple components of the contact center 100.

In a typical application of the contact center 100, a customer or other constituent 105, calls the contact center 100 via the public switched telephone network (“PSTN”) or other network 110. The customer may initiate the call to sign up for long distance service, inquire about a credit card bill, or purchase a catalog item, for example.

Modem contact centers 100 integrally manage customer phone calls and relevant database information through what is known as a computer/telephone integration system (“CTI”) 140. Two contact center components, an interactive voice response system (“IVRS”) 115 and an automatic call/work distribution component (“ACD”) 130, collaborate with the CTI 140 to acquire information about incoming calls and prepare them for subsequent processing in the contact center.

The IVRS 115 queries each incoming caller to ascertain information such as call purpose, product interest, and language requirements. The IVRS 115 typically offers the caller a menu of options, and the caller selects an option by entering a key code or speaking a recognizable phrase.

The ACD 130 detects telephony information from a call without intruding upon the caller. The ACD 130 can determine a caller's telephone number and location, for example. The ACD 130 transfers the telephony information to the CTI 140, which references the information to a database and deduces additional information describing the call. The CTI 140 can compare caller location to a demographic database and predict a caller's annual income, for example. The CTI 140 might also identify the caller as a repeat customer and categorize the caller's historical ordering patterns. The CTI 140 typically updates a customer database with newly acquired information so that components of the contact center 100 can handle incoming calls according to up-to-date information.

In addition to acquiring telephony information about a caller, the ACD 130 distributes calls within the contact center 100. ACD software generally executes in a switching system, such as a private branch exchange. The private branch exchange connects customer calls to terminals 155 operated by contact center agents who have been assigned to answer customer complaints, take orders from customers, or perform other interaction duties. The ACD 130 maintains one or more queues for holding incoming calls until an agent is selected to take the call and the call is routed to the agent. In the case of multiple queues, each queue typically holds a unique category of caller so that each caller is placed on hold in exactly one queue. The ACD's role in selecting an agent to receive an incoming call will be described in detail below.

In alternative embodiments of the invention, the function of the ACD 130 can be replaced by other communications routers. For example, in a contact system 100 using email, an email server and router can distribute electronic messages.

Terminals 155 typically include a telephone and a contact center computer terminal for accessing product information, customer information, or other information through a database. For example, in a contact center 100 implemented to support a catalog-based clothing merchant, the computer terminal 155 for an agent could display static information regarding a specific item of clothing when a customer 105 expresses an interest in purchasing that item. Agents can also view information about the call that the ACD 130 and the IVRS 115 compiled when the call first came into the contact center 100. A desktop application, which is usually a CRM component 135, facilitates an agent's interaction with a caller.

The contact center's communication network 165 facilitates information flow between the components. For a contact center 100 in which all elements are located at the same site, a local area network may provide the backbone for the contact center communication network 165. In contact centers 100 with geographically dispersed components, the communications network 165 may comprise a wide area network, a virtual network, a satellite communications network, or other communications network elements as are known in the art.

A typical contact center 100 includes a workforce management component (“WFM”) 125. The WFM component 125 manages the staffing level of agents in the contact center 100 so that contact center productivity can be optimized. For example, the volume of calls into or out of a contact center 100 may vary significantly during the day, during the week, or during the month. The WFM component 125 can receive historical call volume data from the ACD 130 and use this information to create work schedules for agents. The ACD 130 is one type of activity monitor in the contact center 100. The historical call volume data can be used to predict periods of high call volume and/or other states of the center. The center's operational functions can be adjusted according to the state. Adjustments of operational functions include selecting a resource to deploy, for example selecting one agent over another to service a contact.

A typical contact center 100 also includes a customer relationship management (“CRM”) component 135, which interacts with the CTI 140. The CRM component 135 manages customer databases and derives useful information, for example identifying customer purchase patterns. In addition to managing traditional customer information, the CRM component 135 can assess incoming calls, for example to predict the nature of the call or the likelihood of an order. The CRM component 135 conducts this assessment by comparing information acquired from the call to information stored in the center's databases.

In a typical contact center 100, a performance monitoring module 145 provides measurements and indications of agent performance that are useful to management and to the various components in the contact center 100. Performance monitoring includes but is not limited to quality monitoring and does not always entail monitoring recorded calls.

The performance monitoring module 145 also typically determines the level of agent skill and competency in each of several areas by accessing information from the center components that collect and track agent performance information. Examples of these components include, but are not limited to, the CRM component 135, the performance support module 120, the WFM component 125, the ACD 130, and a quality monitoring system. The relevant skills and competencies for a contact center 100 serving a catalog clothing merchant could include product configuration knowledge (e.g. color options), knowledge of shipping and payment options, knowledge of competitor differentiation, finesse of handling irate customers, and multilingual fluency. In one embodiment, the performance monitoring module 145 stores performance-related information from the center's component systems in a dedicated database and the ACD 130 accesses the dedicated database for call routing decisions. In one embodiment, the performance-related information is periodically or continuously transmitted, for example by the deployment module 123, to at least one contact center manager's terminal 155, giving the manager real-time data on each agent's performance qualifications.

The performance support module 120, according to one embodiment of the present invention, is implemented in software and is installed in or associated with the communications network 165. The performance support module 120 evaluates various aspects of an agent's qualifications and can provide training and support for the agent. A typical performance support module 120 is illustrated in FIG. 1B and comprises a scheduling module 121, a content module 122, a deployment module 123, and an assessment module 124, each of which is capable of interacting with one another. In one embodiment, the performance support module 120 is accessible, for example via the Internet, by potential agents located outside of the contact center 100. Similarly, within the contact center 100, the performance support module 120 typically is directly accessible by each terminal 155.

The assessment module 124 can administer a variety of assessment tests to an agent, including a trait assessment to determine e.g., the agent's personality and cognitive ability. The assessment module 124 typically administers such a trait assessment test only once for each agent, since for most agents, cognitive ability and personality do not change dramatically during employment. Additionally, the assessment module 124 can administer a skills and competencies assessment test to an agent. By administering and evaluating a skills and competencies assessment test, the performance support module 120 can identify knowledge gaps and determine agent qualifications that improve with training and on-the-job experience. Furthermore, by administering and evaluating a trait assessment test, the performance support module 120 can identify learning styles and other key personal characteristics to be utilized for more effective customized training. To that end, hiring and assignment decisions can be made with personality characteristics, including learning styles, personality traits, skills, and competency levels, in mind, ensuring that employees are assigned to the best-suited roles. In one embodiment, the performance support module 120 stores information obtained from assessment tests, assessment data, in a storage medium, e.g., a dedicated assessment database 160, which can be accessed by the ACD 130 for call routing decisions. In one embodiment, the assessment data is periodically or continuously transmitted, for example by the deployment module 123, to at least one contact center manager's terminal 155, giving the manager real-time information regarding each agent's performance qualifications.

In one embodiment, the deployment module 123 is accessible by a call center administrator, for example a manager. Within the deployment module 123, the manager defines the personal characteristics he believes necessary for a particular role. Based upon the manager's personal characteristic definitions, the manager can group personal characteristics into particular models within the deployment module 123. One or more models within the deployment module 123 can define a particular role, a “role definition.” The deployment module 123 then compares the role definition to existing agents' data found within the assessment database 160. Thereafter, the manager deploys the agent(s) with the best overall scores for the role definition for a particular role. In the exemplary embodiments described herein, custom roles can be defined using models and personal characteristics in the deployment module 123. Those skilled in the art will realize that the assessment and deployment functions described in the present invention are not limited to the personal characteristics described herein.

The manager might instead utilize the performance support module 120 to create a role definition based upon existing agents' personal characteristics. For example, if an agent performs exceptionally well in a particular role, the manager can access that agent's assessment data from the assessment database 160 and determine the agent's personal characteristics. The manager can then use the deployment module 123 to create a role definition based upon the exceptional agent's data. In later hiring, training, and assignment decisions related to that role definition, the manager can utilize the deployment module 123 to find agents with similar qualifications to the existing exceptional agent.

Furthermore, in one embodiment, a potential agent, “Applicant,” can access the performance support module 120, specifically the assessment module 124, e.g., from outside the call center, to have his personal characteristics assessed. The data obtained from the assessment of Applicant is stored in the assessment database 160. In later hiring decisions, a manager can access the deployment module 123, define a new role definition or utilize an existing role definition, and search for potential agents, including Applicant, that sufficiently match the qualifications of the role definition.

The performance support module 120 also accepts performance monitoring input from the performance monitoring module 145 as feedback for agent training programs. Under the control of contact center management, the performance support module 120 can assign training materials to agents, with the aid of its content module 122, and deliver those training materials, with the aid of its scheduling module 121, via a communications network 165 to agent terminals 155. The content module 122 ensures that the training materials comprise the appropriate content, e.g., to conform to the particular agent's training needs and learning style. The performance support module 120 is in communication with the performance monitoring module 145 through the communications network 165 so that appropriate training materials may be delivered to the agents who are most in need of training. Proficient agents are thus spared the distraction of unneeded training, and training can be concentrated on those agents most in need and on areas of greatest need for those agents.

Advantageously, contact center management may establish pass/fail or remediation thresholds to enable the assignment of appropriate training to appropriate agents. This functionality may be provided within the performance monitoring module 145. Preferably, agent skills that are found to be deficient relative to the thresholds are flagged and stored in a storage device within the performance monitoring module 145. The scheduling module 121 ensures that the training materials are delivered to agents at the appropriate times, e.g., during down time, when there are no calls in the agent's queue. Integration with the other contact center components enables the performance support module 120 to deliver the training materials to agents at times when those agents are available and when training will not adversely impact the contact center's operations.

With an understanding of each agent's personal characteristics, through the aid of e.g., the deployment module 123, the assessment module 124, and the assessment database 160, training can be administered to more effectively improve agent performance. Once the training is administered, an assessment can be provided to ensure the agent understood and retained the information. In addition, the agent's performance can be monitored to determine if performance has changed based upon the acquisition of the new information. When the agent's performance has changed, the training system can automatically update the agent's personal characteristics data, maintaining a near real time view of agent qualifications.

In tandem with the performance monitoring module 145, the performance support module 120 can determine if an agent effectively practices the subject matter of a completed training session. Immediately following a computer-administered assessment test, the results of the assessment are available to other components coupled to the contact center's information network infrastructure 165. The ACD 130 and other center components access agent qualifications essentially in “real time.” Consequently, the present invention can advantageously base call-routing and training decisions on real-time information related to agent qualifications. Furthermore, the present invention can help call center administrators, e.g., managers, advantageously base hiring, training, and assignment decisions upon real-time information related to agent qualifications.

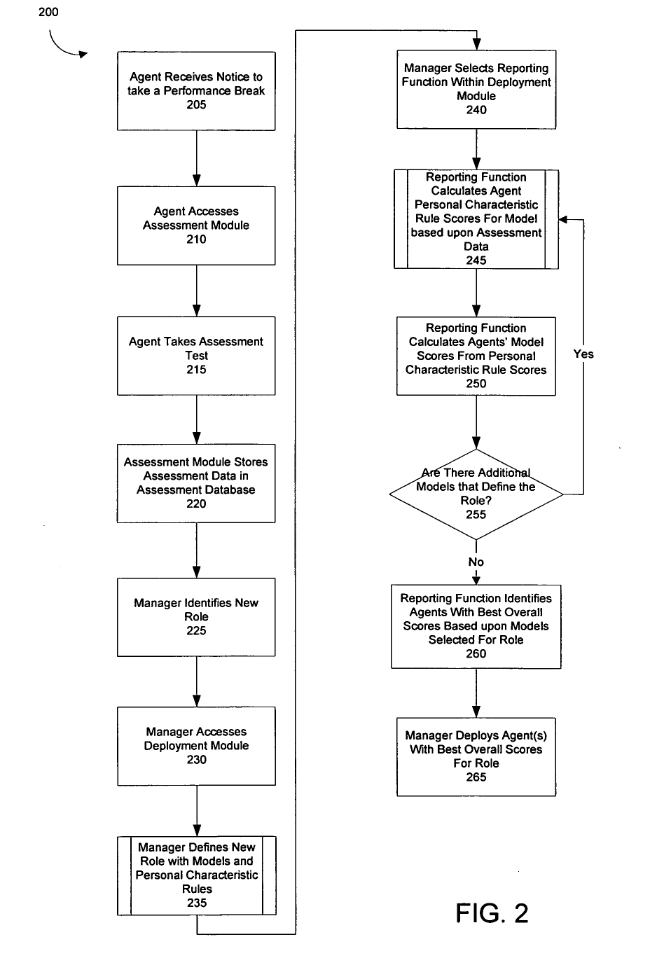

FIG. 2 is a flow chart illustrating steps in a process 200 for 30 assessing and deploying personnel for a role in a computer-based contact center according to an exemplary embodiment of the present invention. In alternative embodiments of the present invention certain of the steps shown in FIG. 2 may be performed in a different order or not performed at all. At step 205, the call center agent receives a performance break notice from the performance support module 120. A performance break is a break that enables an agent to e.g., receive training and take assessment tests. Preferably, the scheduling module 121 schedules such a break during an agent's down time, i.e., when the agent has no calls in his queue. After receiving the performance break notice, the agent accesses the assessment module 124 in step 210 and, in step 215, takes the appropriate assessment test. In step 220, the assessment module 124 delivers the assessment data generated from the agent's performance on the assessment test in step 215 to the assessment database 160.

In step 225, a call center administrator, e.g., a manager, identifies a new call center role for which he must deploy personnel. Note that the placement of step 225 after steps 205-220 is merely illustrative of a specific application of the invented system; the manager might identify a new role before an agent receives notice of, or takes, a particular performance break. Furthermore, the manager need not identify a “new” role—there could be an existing role in the center for which the manager must deploy personnel. If the manager is deploying personnel for a role previously identified with the deployment module 123, the manager can proceed directly to step 240.

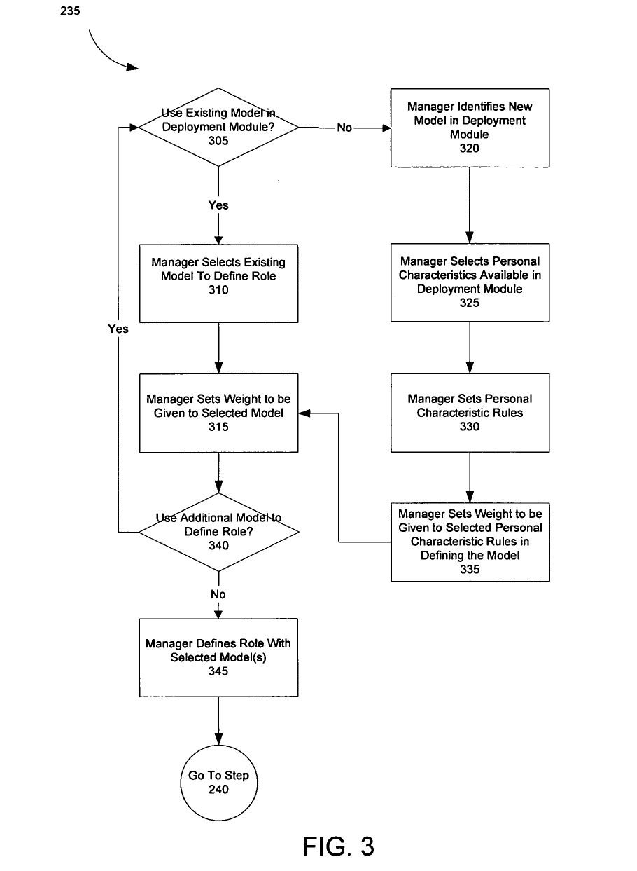

In step 230, the manager accesses the deployment module 123 and, in step 235, within the deployment module 123, he defines a new role using weighted models and personal characteristic rules. Step 235 is described in more detail in conjunction with the description of FIG. 3. In step 240, the manager selects which reporting function within the deployment module 123 to use when displaying the results from steps 245-260 below. Reporting function options include e.g., viewing potential and existing agents in order of their assessment scores, viewing agents that are the “best fit” for a specific role, viewing all the details for a specific agent (or specific agents), and viewing comparisons between agents.

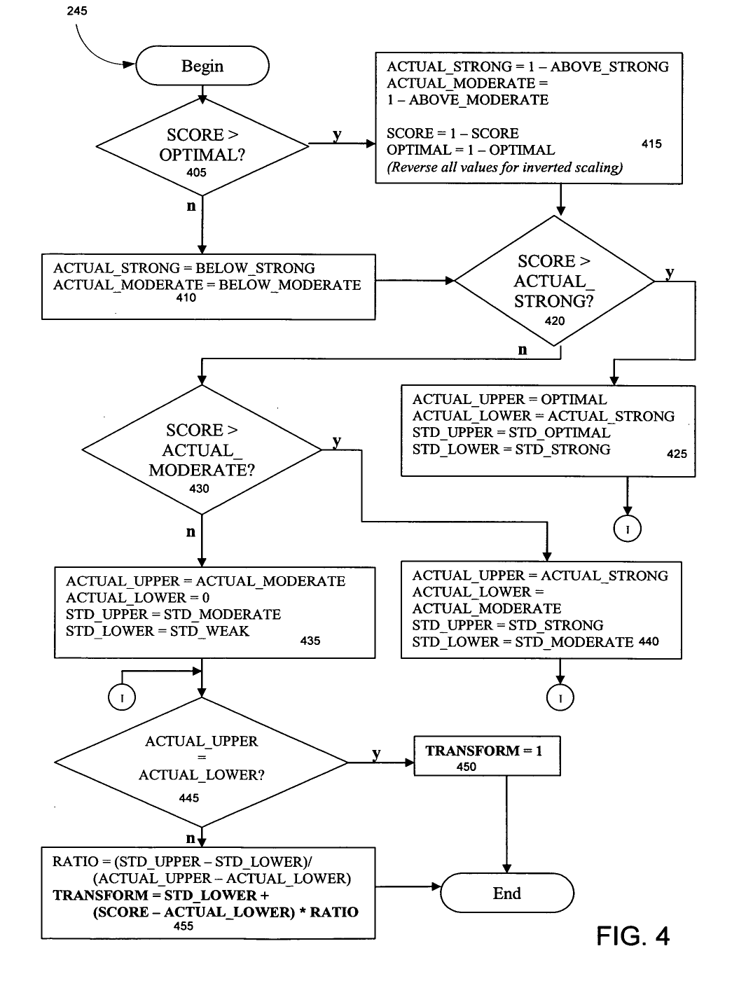

Next, through iteration in accordance with step 255, in steps 245 and 250 the reporting function selected in step 240 calculates the agent personal characteristic rule scores and agent model scores for each role-defining model. Step 245 is described, in conjunction with the description of FIG. 4, in more detail below. Once each agent's personal characteristic rule scores are computed in accordance with step 245, the reporting function calculates agent model scores. In one embodiment, the model score is computed in step 250 as the sum of weighted personal characteristic rule scores. In step 260, the reporting function identifies the agents with the best overall scores for a particular role, which overall scores are based upon agent personal characteristic rule scores and model scores. In doing so, the reporting function identifies those agents with assessment data that indicates they have qualities similar to those identified in a particular role definition. The degree of similarity need not be absolute or even strong for the reporting function to identify a particular agent. Rather, for example, in the particular embodiment described herein, the reporting function will report all similarities, ranking each identified agent by his degree of similarity to the role definition.

Where only one model defines a role, the overall scores are the model scores computed in step 250. Where more than one model is used to define a role, the overall score is the sum of the weighted model scores in the preferred embodiment. Finally, in step 265, the manager deploys the agent(s) with the best overall scores for the new role.

FIG. 3 is a flow chart illustrating steps in a sub-process for defining a role according to an exemplary embodiment of the present invention. In alternative embodiments of the present invention certain of the steps shown in FIG. 3 may be performed in a different order or not performed at all. Exemplary FIG. 3 depicts step 235 from exemplary FIG. 2 in greater detail. Step 305 asks whether, in defining a role, the deployment module 123 should use an existing model, which is already stored in the system. If so, in step 310 the manager selects the existing model he would like to use, and in step 315, he assigns the weight to be given to the selected model. If the manager would like to use a new model to define the role, in step 320, the manager identifies a new model in the deployment module 123. To start defining the new model, the manager selects from among available personal characteristics in the deployment module 123, in step 325, those which he deems appropriate for the new model. In step 330, the manager sets the personal characteristic rules for each of the particular personal characteristics selected in step 325. As described above, personal characteristic rules refer to levels of desirability for particular personal characteristics in a role.

Once the personal characteristic rules have been set, the manager can assign a weight to each personal characteristic rule, on a numerical scale from 0 to 1, in step 335. The sum of the weights given to the personal characteristic rules within a model should be 1. After step 335, the model is complete. The manager then sets a weight to be given to the new model in step 315. The process iterates from step 340 to step 305 and back until each model to be used in the definition of a particular role has been selected (or created) and weighted. Once the iterative process has been completed, the weights selected for each model should add up to 1. After step 340, in step 345, the manager's new role definition is complete—it comprises each of the selected models, each of the selected models' personal characteristic rules, and the weights of each model and personal characteristic rule.

FIG. 4 is a flow chart illustrating steps in a sub-process for calculating personal characteristic rule scores according to an exemplary embodiment of the present invention. In alternative embodiments of the present invention certain of the steps shown in FIG. 4 may be performed in a different order or not performed at all. Exemplary FIG. 4 depicts step 245 from exemplary FIG. 2 in greater detail. An overall role score comprises weighted model scores, which are comprised of weighted personal characteristic rule scores. To calculate a personal characteristic rule score, the actual personal characteristic score of an individual, as determined by the assessment module 124, must be translated to represent its degree of fit within a particular personal characteristic rule. For example, if a personal characteristic rule states that a particular personal characteristic level is optimal at its minimum, i.e., at a level of 0 on a scale of 0-100, a personal characteristic score of 0 translates to a personal characteristic rule score of 100, the optimal level of fitness with the personal characteristic rule. FIG. 4 depicts one exemplary approach to such a translation.

The term “OPTIMAL,” as used in FIG. 4 represents the user supplied value for an optimal personal characteristic score. The term “SCORE” represents the personal characteristic score to be transformed. The term “BELOW_STRONG” represents the user supplied value indicating the cutoff for a strong match if the score falls below optimal. Likewise, the term “BELOW_MODERATE” represents the user supplied value indicating the cutoff for a moderate match if the score falls below optimal. The term “ABOVE_STRONG” represents the user supplied value indicating the cutoff for a strong match if the score falls above optimal. Likewise, the term “ABOVE_MODERATE” represents the user supplied value indicating the cutoff for a moderate match if score falls above optimal.

The terms “ACTUAL_STRONG,” “ACTUAL_MODERATE,” “ACTUAL_UPPER,” “ACTUAL_LOWER,” “STD_UPPER,” “STD_LOWER,” and “RATIO” are variables, the values of which are determined by the computations within FIG. 4. The term “TRANSFORM” is a variable, the value of which equals the translated score.

Referring to exemplary process 245 illustrated in FIG. 4, step 405 asks whether the personal characteristic score as determined by the assessment module 124 is greater than the user-defined optimal score. If so, in step 415, each of the values for variables ACTUAL_STRONG and ACTUAL_MODERATE becomes the reverse (i.e., the inversely scaled) value of its corresponding user-supplied value, ABOVE_STRONG and ABOVE_MODERATE respectively. Additionally, the user supplied values for SCORE and OPTIMAL are likewise reversed for inverted scaling. If not, in step 410 variables ACTUAL_STRONG and ACTUAL_MODERATE are assigned the values of the user-supplied BELOW_STRONG and BELOW_MODERATE values respectively.

In either case, step 420 asks whether the personal characteristic score is greater than the newly-defined value for variable ACTUAL_STRONG. If so, the values for variables ACTUAL_UPPER, ACTUAL_LOWER, STD_UPPER, and STD_LOWER are defined as stated in the box diagram for step 425 and the process continues with step 445. If not, step 430 asks whether the personal characteristic score is greater than the defined value for variable ACTUAL_MODERATE. If so, the values for variables ACTUAL_UPPER, ACTUAL_LOWER, STD_UPPER, and STD_LOWER are defined as stated in the box diagram for step 440. If not, the values for variables ACTUAL_UPPER, ACTUAL_LOWER, STD_UPPER, and STD_LOWER are defined as stated in the box diagram for step 435.

Either way, the process continues with step 445. Step 445 asks whether the values for variables ACTUAL_UPPER and ACTUAL_LOWER are equal. If so, according to step 450, the translated score is 1, representing 100% fit with the personal characteristic rule. If not, the translated score is determined by the calculation found in step 455. The translated score is the personal characteristic rule score.

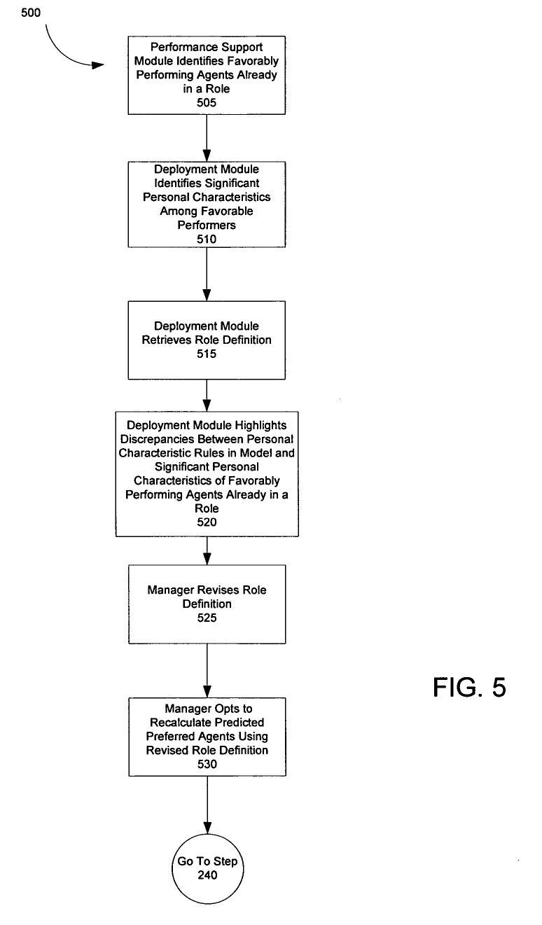

FIG. 5 is a flow chart diagram illustrating steps in a process 500 for modifying the definition of a role according to an exemplary embodiment of the present invention. In alternative embodiments of the present invention certain of the steps shown in FIG. 5 may be performed in a different order or not performed at all. Exemplary process 500 is essentially a feedback mechanism that allows the call center manager to adjust role definitions. In step 505, the performance support module 120 identifies those agents, already assigned in a role, who are favorable performers in their particular role. Next, in step 510, the deployment module 123 identifies significant personal characteristics corresponding to each of the actual favorably performing agents. Those skilled in the art will recognize that there are a variety of methods the deployment module 123 could use to identify significant personal characteristics. For example, the deployment module 123 could identify common personal characteristics shared by the favorable performers. In step 515, the deployment module 123 retrieves the current role definition, and in step 520, it highlights discrepancies between the current role definition's personal characteristic rules and the actual favorably performing agents' significant personal characteristics. Based upon those highlighted discrepancies, in step 525, the manager revises the role definition to reflect more accurately the personal characteristics held by the actual favorable performers. Once the role definition has been redefined, in step 530, the manager may choose to recalculate the predicted preferred agents using the revised role definition. If so, the manager will continue with step 240.

In conclusion, the present invention, as described in the foregoing exemplary embodiments, enables the effective assessment of personnel, both existing and potential, based upon personal characteristics to be utilized in roles in a contact center. Allowing a contact center manager to customize role definitions by varying the weights and combinations of different criteria permits for more accurate assessment of personnel and better deployment of those personnel. It will be appreciated that the preferred embodiment of the present invention overcomes the limitations of the prior art. From the description of the preferred embodiment, equivalents of the elements shown therein will suggest themselves to those skilled in the art, and ways of constructing other embodiments of the present invention will suggest themselves to practitioners of the art. For example, evaluating personnel with customized role definition tools can be applied to a variety of contact center environments. Furthermore, in addition to or in place of the personal characteristics described in connection with the exemplary embodiments, a variety of different criteria can be used to define the customized role definitions. The scope of the present invention is to be limited only by the claims below.

What is claimed is:

1. A method for assessing an agent for a role in a contact center comprising the steps of:
providing at least one assessment to an agent;
storing agent assessment data produced from the at least one assessment in a storage medium;
receiving a role definition associated with the role and associated with a deployment module, wherein the role definition comprises at least one model and the model comprises at least one personal characteristic rule; and
computing an overall score for the agent by applying the role definition to the agent assessment data.

2. The method of claim 1, further comprising the step of identifying whether the agent is suited for the role associated with the role definition based on the overall score.

3. The method of claim 1, wherein the step of receiving a role definition comprises:
identifying the role;
selecting the at least one model associated with the role; and
setting a weight for the selected at least one model.

4. The method of claim 1, wherein the step of receiving a role definition comprises the steps of:
identifying the role;
identifying the at least one model associated with the role;
selecting at least one personal characteristic associated with the identified at least one model;
setting the at least one personal characteristic rule associated with the selected at least one personal characteristic;
setting a weight for the at least one personal characteristic rule; and
setting a weight for the at least one model.

5. The method of claim 1, wherein the step of computing the overall score comprises:
transforming the agent assessment data to at least one personal characteristic rule score using the at least one personal characteristic rule;
applying a weight to the at least one personal characteristic rule score to calculate at least one model score; and
applying a weight to the at least one model score to calculate the overall score.

6. The method of claim 1, wherein the deployment module periodically transmits assessment data to at least one terminal.

7. The method of claim 1, wherein the deployment module continuously transmits assessment data to at least one terminal.

8. A method for identifying a preferred agent for a role in a contact center comprising the steps of:
storing assessment data for a plurality of agents in a storage medium;
receiving a role definition associated with a deployment module, the role definition comprising at least one model, the at least one model comprising at least one personal characteristic rule;
computing overall scores from the assessment data for each of the plurality of agents using the role definition; and
identifying the preferred agent for the role from the plurality of agents based on the computed overall scores.

9. The method of claim 8, further comprising the step of deploying the preferred agent based on the computed overall scores.

10. The method of claim 8, wherein the step of receiving a role definition comprises:
identifying the role;
selecting the at least one model associated with the role; and
setting a weight for the selected at least one model.

11. The method of claim 8, wherein the step of receiving a role definition comprises the steps of:
identifying the role;
identifying the at least one model associated with the role;
selecting at least one personal characteristic associated with the identified at least one model;
setting the at least one personal characteristic rule associated with the selected at least one personal characteristic;
setting a weight for the selected at least one personal characteristic rule; and
setting a weight for the model.

12. The method of claim 8, wherein the step of computing the overall score comprises:
transforming the assessment data to at least one personal characteristic rule score using at least one personal characteristic rule;
applying a weight to the at least one personal characteristic rule score to calculate at least one model score; and
applying a weight to the at least one model score to calculate the overall score.

13. The method of claim 8, wherein the deployment module periodically transmits assessment data to at least one terminal.

14. The method of claim 8, wherein the deployment module continuously transmits assessment data to at least one terminal.

15. A method for assessing agents for a role in a contact center comprising the steps of:
arranging for an assessment of at least one agent, the assessment producing assessment data that is stored;
defining a role with a deployment module, the role definition comprising at least one model, the at least one model comprising at least one personal characteristic rule;
computing at least one overall score with the deployment module from the assessment data; and
identifying a preferred agent from the at least one agent based on the computed at least one overall score.

16. The method of claim 15, further comprising the step of assigning the preferred agent to the role.

17. The method of claim 15, wherein the step of defining a role comprises:
identifying the role;
selecting the at least one model associated with the role; and
setting a weight for the selected at least one model.

18. The method of claim 15, wherein the step of defining a role comprises:
identifying the role;
identifying the at least one model associated with the role;
selecting at least one personal characteristic associated with the at least one model;
setting the at least one personal characteristic rule associated with the at least one personal characteristic;
setting a weight for the at least one personal characteristic rule; and
setting a weight for the at least one model.

19. The method of claim 15, wherein the step of computing the at least one overall score comprises:
transforming the assessment data to at least one personal characteristic rule score using the at least one personal characteristic rule;
applying a weight to the at least one personal characteristic rule score to calculate at least one model score; and
applying a weight to the at least one model score to calculate the at least one overall score.

20. The method of claim 15, wherein the deployment module periodically transmits assessment data to at least one terminal.

21. The method of claim 15, wherein the deployment module continuously transmits assessment data to at least one terminal.

22. A method for modifying the assessment of agents for a role in a contact center comprising the steps of:
identifying at least one favorably performing agent already in a role;
identifying at least one significant personal characteristic of the at least one favorably performing agent with a deployment module;
retrieving a role definition for the role with the deployment module; and
modifying the role definition by modifying at least one personal characteristic rule associated with the at least one significant personal characteristic of the at least one favorably performing agent.

23. The method of claim 22, further comprising the step of computing at least one overall score for at least one agent with the deployment module and the modified role definition.

24. The method of claim 22, wherein the step of identifying the at least one favorably performing agent comprises analyzing performance data for the agent.

25. The method of claim 22, wherein the step of modifying the role definition further comprises modifying a weight assigned to the at least one personal characteristic rule.

26. The method of claim 22, wherein the deployment module periodically transmits assessment data to at least one terminal.

27. The method of claim 22, wherein the deployment module continuously transmits assessment data to at least one terminal.

28. The method of claim 23 further comprising identifying a preferred agent from the at least one agent based on the computed at least one overall score.

29. The method of claim 28, further comprising the step of assigning the preferred agent to the role.

30. A system for assessing an agent for a role in a contact center comprising:
a data storage medium comprising agent assessment data;
a deployment module coupled to the data storage medium, the deployment module comprising a role definition and operable for
relating at least one personal characteristic rule to at least one model,
weighting the at least one personal characteristic rule,
relating the at least one model to the role definition,
weighting the at least one model, and
calculating an overall score for the agent with the role definition and the agent assessment data.

31. The system of claim 30, wherein the deployment module is further operable for
transforming the agent assessment data to at least one personal characteristic rule score using the at least one personal characteristic rule;
calculating at least one model score from the at least one personal characteristic rule score and the at least one personal characteristic rule weighting; and
calculating an overall score from the at least one model score and the at least one model weighting.

32. The system of claim 30, wherein the deployment module is further coupled to an assessment module operable for collecting the agent assessment data.

33. The system of claim 30, wherein the deployment module is further coupled to a content module operable for providing training content to an agent.

34. The system of claim 30, wherein the deployment module is further operable for
identifying at least one significant personal characteristic for a favorably performing agent already in a role; and
receiving a modified role definition based on the identified at least one significant personal characteristic.

35. The system of claim 30, wherein the deployment module is further operable for periodically transmitting the assessment data to at least one terminal.

36. The system of claim 30, wherein the deployment module is further operable for continuously transmitting the assessment data to at least one terminal.

37. The system of claim 33, wherein the training content is customized based upon an agent's assessment data.

38. A method for providing training to an agent in a contact center comprising the steps of:
providing at least one assessment to an agent;
storing agent assessment data produced from the at least one assessment in a storage medium;
receiving a role definition associated with a role and associated with a deployment module, wherein the role definition comprises at least one model and the model comprises at least one personal characteristic rule;
computing an overall score for the agent by applying the role definition to the agent assessment data; and
assigning training to the agent for the role based on the overall score.

39. The method of claim 38, wherein the step of receiving a role definition comprises:
identifying the role;
selecting the at least one model associated with the role; and
setting a weight for the selected at least one model.

40. The method of claim 38, wherein the step of receiving a role definition comprises the steps of:
identifying the role;
identifying the at least one model associated with the role;
selecting at least one personal characteristic associated with the identified at least one model;
setting the at least one personal characteristic rule associated with the selected at least one personal characteristic;
setting a weight for the at least one personal characteristic rule; and
setting a weight for the at least one model.

41. The method of claim 38, wherein the step of computing the overall score comprises:
transforming the agent assessment data to at least one personal characteristic rule score using the at least one personal characteristic rule;
applying a weight to the at least one personal characteristic rule score to calculate at least one model score; and
applying a weight to the at least one model score to calculate the overall score.

42. The method of claim 38, wherein the deployment module transmits assessment data to at least one terminal.

43. A method for assigning an agent to a supervisor in a contact center comprising the steps of:
providing at least one assessment to an agent;
storing agent assessment data produced from the at least one assessment in a storage medium;
receiving a role definition associated with a role and associated with a deployment module, wherein the role definition comprises at least one model and the model comprises at least one personal characteristic rule;
computing an overall score for the agent by applying the role definition to the agent assessment data; and
assigning the agent to the supervisor for the role based on the overall score.

44. The method of claim 43, wherein the step of receiving a role definition comprises:
identifying the role;
selecting the at least one model associated with the role; and
setting a weight for the selected at least one model.

45. The method of claim 43, wherein the step of receiving a role definition comprises the steps of:
identifying the role;
identifying the at least one model associated with the role;
selecting at least one personal characteristic associated with the identified at least one model;
setting the at least one personal characteristic rule associated with the selected at least one personal characteristic;
setting a weight for the at least one personal characteristic rule; and
setting a weight for the at least one model.

46. The method of claim 43, wherein the step of computing the overall score comprises:
transforming the agent assessment data to at least one personal characteristic rule score using the at least one personal characteristic rule;
applying a weight to the at least one personal characteristic rule score to calculate at least one model score; and
applying a weight to the at least one model score to calculate the overall score.

47. The method of claim 43, wherein the deployment module transmits assessment data to at least one terminal.
